(19) United States
(12) Patent Application Publication
(10) Pub. No.: US 2011/0064403 A1
(43) Pub. Date: Mar. 17, 2011

(54) Domed-shaped camera

(75) Inventors: Yoichi Nakano, Tokyo-to (JP); Hiroyuki Ishiwata, Kanagawa-ken (JP)

(73) Assignee: Victor Company of Japan, Ltd., Yokohama (JP)

(21) Appl. No.: 12/923,192

(22) Filed: Sep. 8, 2010

(30) Foreign Application Priority Data
Sep. 16, 2009 (JP) 2009-214290
Sep. 16, 2009 (JP) 2009-214306

(51) Int. Cl. G03B 17/02

(52) U.S. Cl. 396/535

(57) ABSTRACT

A dome-shaped camera includes a casing having an axis. A camera unit is supported on the casing. A dome-shaped cover is at least partly transparent, and covers the camera unit. A flange portion has a first contact portion and a second contact portion. The first contact portion is in contact with an end of the dome-shaped cover. The second contact portion is in contact with the casing. A position of the first contact portion in a radial direction with respect to the axis of the casing differs from that of the second contact portion. The flange portion is fixed to the casing.

### BACKGROUND OF THE INVENTION

1. Field of the Invention

This invention generally relates to a dome-shaped camera. This invention particularly relates to a dome-shaped camera shock-resistant or impact-resistant and able to withstand even when being struck with a hammer or a bat.

2. Description of the Related Art

There is a dome-shaped camera used as a surveillance camera. The dome-shaped camera has a transparent dome-shaped cover and a camera unit placed therein. The cover is smoked to make the camera inconspicuous.

There is a possibility that a surveillance camera is struck with a hammer or a bat and is thereby broken.

An advanced dome-shaped camera is designed to be shock-resistant or impact-resistant and able to withstand even when being struck with a hammer or a bat. In such an advanced camera, a dome-shaped cover is made of impact-resistant polycarbonate (PC) resin while a casing supporting the cover is made of metal such as aluminum.

Japanese patent application publication number 2003-174572 discloses a surveillance camera having a dome-shaped cover and a camera unit placed therein. In the surveillance camera of Japanese application 2003-174572, the cover is made of PC resin, and the camera unit is connected with a bracket by shaft screws. The bracket has vertically elongated holes through which the shaft screws extend respectively. Coil springs urge the shaft screws so that they will be normally located at limit positions in the elongated holes. The shaft screws can move vertically from their normal positions along the elongated holes against the forces of the coil springs. As the camera unit moves vertically, the shaft screws move together with the camera unit. Thus, in the event that the cover is struck and the camera unit receives a corresponding impact force, the camera unit moves vertically while the shaft screws move vertically against the forces of the coil springs. Thereby, the impact force is absorbed by the coil springs, and the camera unit is prevented from being damaged.

It is desirable that a cover in a dome-shaped camera hardly deforms even when receiving an impact force. Furthermore, it is desirable that a camera unit in a dome-shaped camera is more reliably prevented from being damaged even when a cover in the camera is struck. In addition, it is desirable to make an impact-resistant dome-shaped camera more compact.

### SUMMARY OF THE INVENTION

It is a first object of this invention to provide a dome-shaped camera in which a cover hardly deforms even when receiving an impact force, and a camera unit is more reliably prevented from being damaged even when the cover is struck.

It is a second object of this invention to provide a dome-shaped camera which is impact-resistant and more compact.

A first aspect of this invention provides a dome-shaped camera comprising a casing having an axis; a camera portion supported on the casing; a dome-shaped cover being at least partly transparent and covering the camera portion; a flange portion having a first contact portion and a second contact portion, the first contact portion being in contact with an end of the dome-shaped cover, the second contact portion being in contact with the casing, wherein a position of the first contact portion in a radial direction with respect to the axis of the casing differs from that of the second contact portion; and means for fixing the flange portion to the casing.

A second aspect of this invention is based on the first aspect thereof, and provides a dome-shaped camera further comprising an inner cover placed inward of the dome-shaped cover and covering the camera portion, the inner cover having an opening corresponding to an image taking range of the camera portion; and a third contact portion provided on the casing at a position radially inward of an outer circumference of the casing, the third contact portion being in contact with an end surface of the inner cover.

A third aspect of this invention is based on the first aspect thereof, and provides a dome-shaped camera wherein the camera portion is elastically movable toward the casing in a direction along the axis of the casing.

A fourth aspect of this invention is based on the second aspect thereof, and provides a dome-shaped camera wherein the camera portion is elastically movable toward the casing in a direction along the axis of the casing.

A fifth aspect of this invention provides a dome-shaped camera comprising a camera portion; an arm portion having one end connected with the camera portion; a gimbals base with which an other end of the arm portion is integrally connected; a casing having an axis and a support portion for elastically supporting the gimbals base; and a dome-shaped cover attached to the casing and covering the camera portion, the dome-shaped cover being at least partly transparent; wherein an image of the gimbals base projected onto a plane perpendicular to the axis of the casing is smaller in area than an image of the camera portion projected onto the plane.

A sixth aspect of this invention is based on the fifth aspect thereof, and provides a dome-shaped camera wherein the support portion comprises means for urging the gimbals base in a direction away from the casing and parallel to the axis of the casing, and means for limiting movement of the gimbals base in the direction away from the casing and parallel to the axis of the casing.

A seventh aspect of this invention is based on the fifth aspect thereof, and provides a dome-shaped camera further comprising an inner cover placed inward of the dome-shaped cover and covering the camera portion, the inner cover having an opening corresponding to an image taking range of the camera portion, the inner cover further having a guide portion in engagement with the arm portion for guiding the arm portion along the axis of the casing.

An eighth aspect of this invention is based on the fifth aspect thereof, and provides a dome-shaped camera further comprising at least one of a circuit board and electronic parts placed in the casing at a position radially outward of the support portion.

A ninth aspect of this invention is based on the sixth aspect thereof, and provides a dome-shaped camera further comprising an inner cover placed inward of the dome-shaped cover and covering the camera portion, the inner cover having an opening corresponding to an image taking range of the camera portion, the inner cover further having a guide portion in engagement with the arm portion for guiding the arm portion along the axis of the casing.

A tenth aspect of this invention is based on the sixth aspect thereof, and provides a dome-shaped camera further comprising at least one of a circuit board and electronic parts placed in the casing at a position radially outward of the support portion.

An eleventh aspect of this invention is based on the seventh aspect thereof, and provides a dome-shaped camera further comprising at least one of a circuit board and electronic parts placed in the casing at a position radially outward of the support portion.

### BRIEF DESCRIPTION OF THE DRAWINGS

FIG. 1 is a perspective view of a dome-shaped camera according to an embodiment of this invention.

FIG. 2 is an exploded perspective view of the dome-shaped camera in FIG. 1.

FIG. 3 is an exploded perspective view of a camera unit in the dome-shaped camera in FIG. 1.

FIG. 4 is a perspective view of a casing in the dome-shaped camera in FIG. 1.

FIG. 5 is an exploded perspective view of a cover in the dome-shaped camera in FIG. 1.

FIG. 6 is a sectional view of a portion of the cover as taken along the line S1-S1 of FIG. 5.

FIG. 7 is a sectional view of a portion of the dome-shaped camera in FIG. 1.

### DETAILED DESCRIPTION OF THE INVENTION

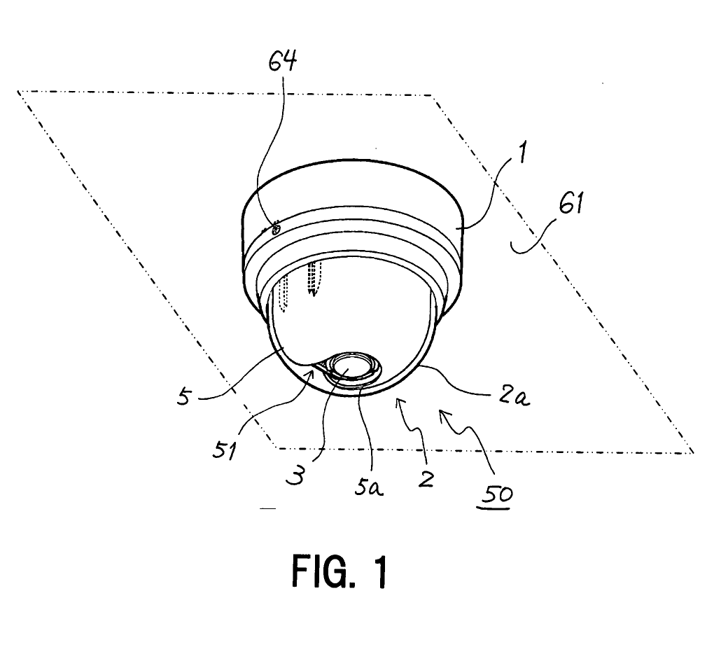

With reference to FIG. 1, a dome-shaped camera 50 has a base portion fitting into a hole in a ceiling board 61 and fixed to the ceiling board 61. The dome-shaped camera 50 includes a casing 1 and a cover 2 attached to the casing 1. The cover 2 has a dome-shaped member 2a. The dome-shaped camera 50 is placed relative to the ceiling board 61 in a manner such that the casing 1 and the cover 2 are exposed.

The casing 1 takes a cylindrical shape, and is made of resin. The casing 1 is formed by, for example, injection molding. Preferably, the resin for the casing 1 is impact-resistant (shock-resistant). Examples of the impact-resistant resin are polycarbonate (PC) resin and PC/ABS (acrylonitrile butadiene styrene) alloy resin.

The cover member 2a is transparent (pervious to light) and approximately hemispherical. The cover member 2a may be semitransparent (partly transparent). The cover member 2a is coaxial with the casing 1. Preferably, the cover member 2a is made of PC resin which is at least partly transparent and impact-resistant.

The cover member 2a may be smoked or colored, for example, gray to make inconspicuous the interior of the dome-shaped camera 50. The mean thickness of the cover member 2a is equal to, for example, 2 mm.

A camera unit 51 having a lens section 3 is placed in the interior of the cover member 2a. The camera unit 51 is covered with the cover member 2a. Furthermore, a part of the camera unit 51 is covered with an inner cover 5. The inner cover 5 has a slit-like opening 5a at a position corresponding to the lens section 3. The lens section 3 and the inner cover 5 can be seen from the exterior through the cover member 2a.

Preferably, the inner cover 5 is made of opaque resin. The inner cover 5 is formed by, for example, injection molding. Examples of the resin for the inner cover 5 are ABS resin and PC resin. Preferably, the inner cover 5 is black. The mean thickness of the inner cover 5 is equal to, for example, 1.5 mm.

The inner cover 5 takes an approximately hemispherical shape. The inner cover 5 is coaxially or concentrically placed in the cover member 2a. Preferably, there is a prescribed radial spacing or clearance A between the cover member 2a and the inner cover 5 (see FIG. 7).

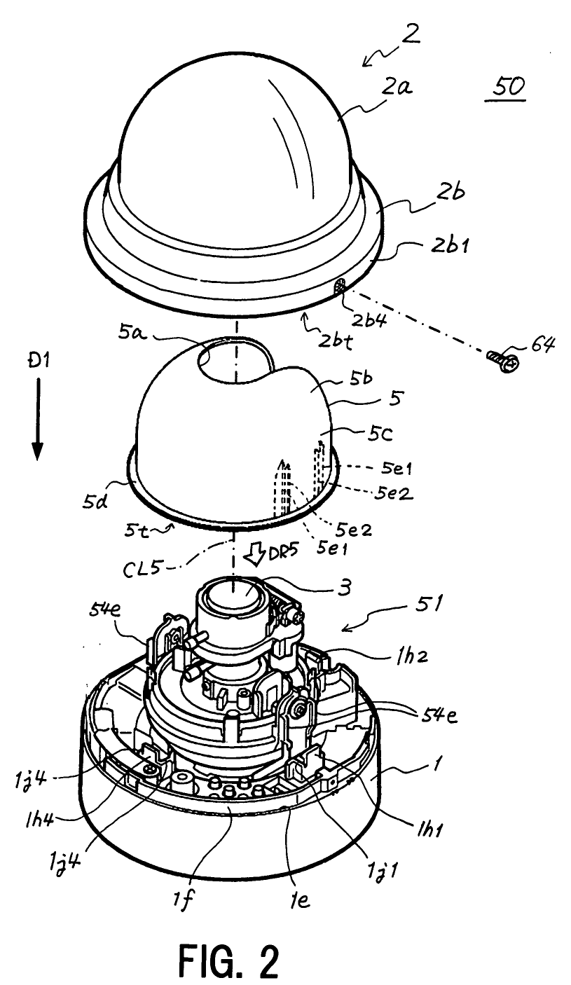

FIG. 2 shows the casing 1, the cover 2, and the inner cover 5 which are inverted with respect to those in FIG. 1 for an easier understanding. With reference to FIG. 2, during the assembly of the dome-shaped camera 50, the inner cover 5 and the cover 2 are moved toward the casing 1 along an axial direction D1 before being attached to the casing 1. The inner cover 5 and the cover 2 are coaxial with the casing 1. The camera unit 51 is mounted on the casing 1.

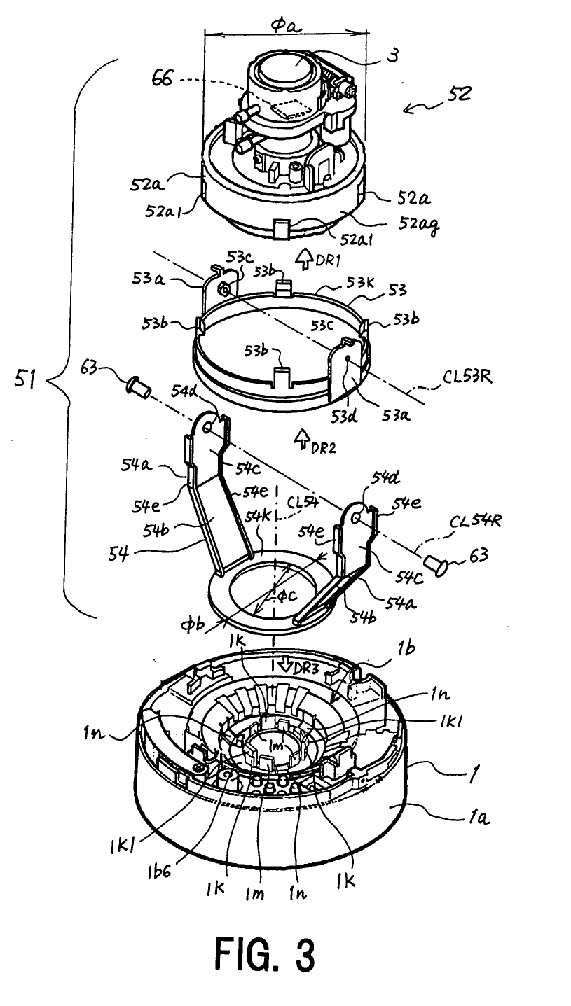

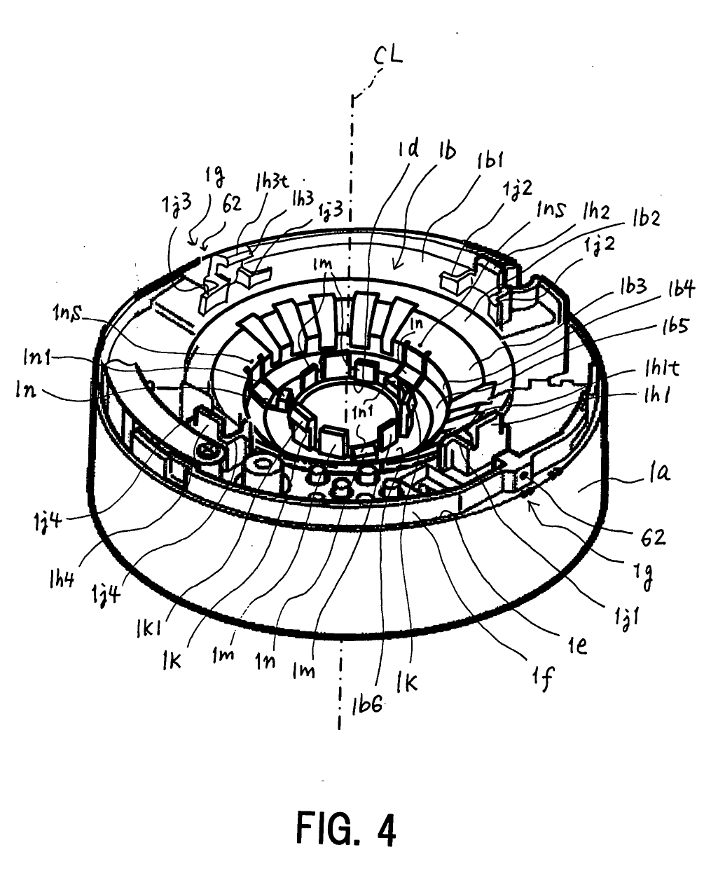

With reference to FIGS. 3 and 4, the casing 1 includes an outer cylindrical portion 1a and a ceiling portion 1b. There is an axis (a center line) CL with respect to the casing 1. The outer cylindrical portion 1a has an outer circumferential surface. The ceiling portion 1b closes at least part of one end of the outer cylindrical portion 1a. The ceiling portion 1b has a step-like hole of a circular cross-section which varies stepwise along an axial direction. The depth of the step-like hole at a radial position increases as the radial position moves toward the axis (center line) CL of the casing 1.

In more detail, the ceiling portion 1b has a ring-shaped reference plane portion 1b1, a first tapered portion 1b2, a second tapered portion 1b3, an inner circumferential plane portion 1b4, a third tapered portion 1b5, and a bottom portion 1b6 which are arranged in that order. The reference plane portion 1b1 extends in an outermost part of the ceiling portion 1b, and has a flat annular surface perpendicular to the casing axis CL. The first tapered portion 1b2 extends inward from the reference plane portion 1b1, and has a tapered surface and an inside diameter which gradually decreases as viewed in the depth-wise direction. The second tapered portion 1b3 extends inward from the first tapered portion 1b2, and has a tapered surface steeper than that of the first tapered portion 1b2 and an inside diameter which gradually decreases as viewed in the depth-wise direction. The inner circumferential plane portion 1b4 extends axially from an innermost part of the second tapered portion 1b3, and has an inner circumferential surface parallel to the casing axis CL. The third tapered portion 1b5 extends inward from the inner circumferential plane portion 1b4, and has a tapered surface and an inside diameter which gradually decreases as viewed in the depth-wise direction. The bottom portion 1b6 extends inward from the third tapered portion 1b5, and has a flat annular surface perpendicular to the casing axis CL. The bottom portion 1b6 is formed with a circular opening 1d coaxial with the casing axis CL.

The ceiling portion 1b has a step le extending throughout the outer circumferential edge thereof and connecting with the outer cylindrical portion 1a. The step 1e has a surface perpendicular to the casing axis CL.

The ceiling portion 1b has a circumferential wall portion 1f located radially inward of the step le and extending parallel to the casing axis CL. The circumferential wall portion 1f is formed with a pair of connecting portions 1g in which nuts 62 are embedded respectively. The connecting portions 1g are diametrically opposed to each other. In other words, the connecting portions 1g are circumferentially spaced at an angular interval of 180°. The nuts 62 are diametrically aligned so as to have a common axis which crosses the casing axis CL at right angles.

The ceiling portion 1b has four axial projections 1h1, 1h2, 1h3, and 1h4 located radially inward of the circumferential wall portion 1f and circumferentially spaced at angular intervals of 90°. The projections 1h1 and 1h3 are diametrically opposed to each other. The projections 1h1 and 1h3 are formed with inwardly-facing hook-shaped claws 1h1t and 1h3t, respectively. Thus, the projections 1h1 and 1h3 are called the claw-added projections also. The projections 1h2 and 1h4 are diametrically opposed to each other. Each of the projections 1h2 and 1h4 is in the form of a board piece without a claw. Thus, the projections 1h2 and 1h4 are called the claw-less projections also.

The ceiling portion 1b has contact ribs 1j1, 1j2, 1j3, and 1j4 provided on and axially projecting from the reference plane portion 1b1. As viewed in FIGS. 3 and 4, the contact ribs 1j1, 1j2, 1j3, and 1j4 have top or upper surfaces 1j1t, 1j2t, 1j3t, and 1j4t (see FIG. 7) whose axial positions are the same. Thus, the heights (axial dimensions) of the contact ribs 1j1, 1j2, 1j3, and 1j4 are equal. The contact ribs 1j1 extend from the projection 1h1 in opposite circumferential directions, respectively. The contact ribs 1j1 connect with the projection 1h1. The contact ribs 1j2 extend from the projection 1h2 in opposite circumferential directions, respectively. The contact ribs 1j2 connect with the projection 1h2. The contact ribs 1j3 extend from the projection 1h3 in opposite circumferential directions, respectively. The contact ribs 1j3 connect with the projection 1h3. The contact ribs 1j4 extend from the projection 1h4 in opposite circumferential directions, respectively. The contact ribs 1j4 connect with the projection 1h4.

The inner edge of the bottom portion 1b6 which defines the opening 1d has engagement projections 1k and wall projections 1m extending in directions parallel to the casing axis CL. There are three engagement projections 1k circumferentially spaced at angular intervals of 120°. Each of the engagement projections 1k is formed with a claw 1k1 projecting radially outward. There are six wall projections 1m which are circumferentially arranged. Two wall projections 1m are located at opposite sides of each engagement projection 1k, respectively.

The ceiling portion 1b has three support arms 1n circumferentially spaced at angular intervals of 120°. There is a positional phase difference of 60° in the circumferential direction between the support arms 1n and the engagement projections 1k. The support arms 1n are flexible and elastically deformable.

The distal end of each of the support arms 1n is formed with a contact portion 1n1 projecting in a direction parallel to the casing axis CL. The directions in which the contact portions 1n1 project are equal or similar to the directions of the engagement projections 1k.

Each of the support arms 1n has a base forming a fulcrum 1ns located in the second tapered portion 1b3. Each support arm 1n is formed by a part of the ceiling portion 1b which is sandwiched between a pair of slits extending from the second tapered portion 1b3 to the opening 1d. Each support arm 1n is flexible and swingable about its fulcrum 1ns. When each support arm 1n receives a force in a direction parallel to the casing axis CL (a downward direction as viewed in FIG. 4), the support arm 1 elastically bends along a direction corresponding to the direction of the force.

The engagement projections 1k and the wall projections 1m have radially-outward-facing surfaces which are approximately inscribed in a circle centered at the casing axis CL and having a first prescribed diameter. The distal ends of the claws 1k1 of the engagement projections 1k are inscribed in a circle centered at the casing axis CL and having a second prescribed diameter greater than the first prescribed diameter.

As shown in FIG. 3, the camera unit 51 includes a camera body 52, a ring bracket 53 in engagement with the camera body 52, and a gimbals 54 supporting the ring bracket 53.

The camera body 52 is placed in the inner cover 5. Preferably, there is a prescribed spacing or clearance between the inner cover 5 and the camera body 52 (see FIG. 7).

The camera body 52 includes a lens section 3, an image sensor 66, and a camera base 52a. An image of a subject is focused onto the image sensor 66 through the lens section 3. The image sensor 66 converts the image into an electric signal. The camera base 52a supports the lens section 3, the image sensor 66, and other members. The electric signal is transmitted from the image sensor 66 via a cable (not shown in FIG. 3).

The camera base 52a has an outer circumferential surface 52ag provided with four engagement portions 52a1 which are circumferentially spaced at angular intervals of 90°. The engagement portions 52a1 are designed for connection with engagement claws 53b (mentioned later) on the ring bracket 53.

The camera base 52a takes a cylindrical shape having a prescribed outside diameter φa. Preferably, the camera base 52a is made of resin such as PC resin. The camera base 52a is formed by, for example, injection molding.

The lens section 3 is provided with mechanisms (not shown) designed to allow focusing and zooming adjustments.

The ring bracket 53 has an annular base 53k, two support tabs 53a, and four engagement claws 53b. The support tabs 53a are provided on the annular base 53k, and are diametrically opposed to each other. Thus, the support tabs 53a are circumferentially spaced at an angular interval of 180°. The engagement claws 53b are provided on the annular base 53k, and are circumferentially spaced at angular intervals of 90°.

Preferably, the ring bracket 53 is made of resin such as PC resin. The ring bracket 53 is formed by, for example, injection molding.

The support tabs 53a have inwardly-facing surfaces to which nuts 53c are fixed respectively by, for example, welding. The nuts 53c are diametrically aligned so as to have a common axis CL53R. As will be made clear later, the ring bracket 53 is rotatable about the axis CL53R. Accordingly, the axis CL53R is referred to as a rotation axis also.

Each of the support tabs 53a has a circular aperture 53d coaxial with and corresponding in diameter to the threaded hole in the related nut 53c. For each of the support tabs 53a, a bolt or screw 63 can extend through the aperture 53d and mesh with the nut 53c.

The axis CL53R of the nuts 53c crosses the casing axis CL at right angles under the conditions where the dome-shaped camera 50 has been assembled.

The gimbals 54 has an annular base 54k and a pair of arms 54a. The arms 54a extend upward and radially outward from the base 54k as viewed in FIG. 3. Preferably, the arms 54a are integral with the base 54k. The base 54k takes a ring shape having an axis (a center line) CL54 and a prescribed outside diameter φb smaller than the outside diameter φa of the camera base 52a. The arms 54a on the base 54k are diametrically opposed to each other. In other words, the arms 54a are circumferentially spaced at an angular interval of 180°. In FIG. 3, the arms 54a project from the base 54k in directions intermediate between axially upward directions and radially outward directions. Thus, the diametrical distance between same-axial-position portions (same-height portions) of the arms 54a increases as the same-axial-position portions move away from the base 54k.

Each of the arms 54a has a slant portion 54b extending from the base 54k and inclined with respect to the base axis CL54, and an engagement portion 54c extending from the slant portion 54b in a direction parallel to the base axis CL54. The engagement portion 54c occupies a distal end of the related arm 54a.

The engagement portions 54c have circular apertures 54d for accommodating the screws 63, respectively. The screws 63 have heads designed to abut against the engagement portions 54c. The apertures 54d are diametrically aligned so as to have a common axis CL54R which crosses the base axis CL54 at right angles. As will be made clear later, the gimbals 54 is rotatable about the axis CL54R. Accordingly, the axis CL54R is referred to as a rotation axis also.

The diametrical distance between the inwardly-facing surfaces of the engagement portions 54c is equal to or slightly greater than the diametrical distance between the outwardly-facing surfaces of the support tabs 53a on the ring bracket 53.

Preferably, the gimbals 54 is made of resin such as PC resin. The gimbals 54 is formed by, for example, injection molding.

Each of the engagement portions 54c has ribs 54e at opposite sides thereof. The ribs 54e enhance the rigidity of the related engagement portion 54c. The ribs 54e are designed for engagement with the inner cover 5 as will be explained later.

Preferably, the outside diameter φa of the camera base 52a is equal to 57.6 mm while the outside diameter φb of the gimbals base 54k is equal to 42.0 mm. In this case, the ratio of the area Sb of an axially-projected outer circle of the gimbals base 54k to the area Sa of an axially-projected outer circle of the camera base 52a is equal to 0.532. Preferably, the area Sb of the axially-projected outer circle of the gimbals base 54k is significantly smaller than the area Sa of the axially-projected outer circle of the camera base 52a.

Accordingly, it is preferable that an image of the gimbals base 54k projected onto a plane perpendicular to the casing axis CL is smaller in area than an image of the camera base 52a projected on the plane.

The gimbals base 54k has a prescribed inside diameter φc. Preferably, the inside diameter φc is approximately equal to the diameter of the circle in which the engagement projections 1k and the wall projections 1m on the casing 1 are inscribed.

The gimbals base 54k is in engagement with the ceiling portion 1b of the casing 1 (the bottom portion 1b of the casing 1 as viewed in FIG. 3) via a snap fit. The gimbals base 54k is supported on the ceiling portion 1b of the casing 1.

Referring to FIGS. 3 and 4, the camera unit 51 is assembled with respect to the casing 1 as follows. First, the ring bracket 53 is moved toward the camera base 52a of the camera body 52 along a direction DR1 in FIG. 3 before being connected with the camera base 52a. At the time of the connection of the ring bracket 53 with the camera base 52a, the claws 53b on the ring bracket 53 are forced into engagement with the engagement portions 52a1 on the camera base 52a.

Thereafter, the gimbals 54 is moved toward the camera body 52 with the ring bracket 53 along a direction DR2 in FIG. 3, and the rotation axis CL53R of the ring bracket 53 and the rotation axis CL54R of the gimbals 54 are made to coincide with each other.

Under the conditions where the rotation axes CL53R and CL54R coincide with each other, the bolts 63 are passed through the apertures 54d of the gimbals 54 and the apertures 53d of the ring bracket 53 before being made to mesh with the nuts 53c. Thus, the camera body 52, the ring bracket 53, and the gimbals 54 are combined together.

Thereby, the camera body 52 is rotatable about the rotation axis CL54R so that camera's tilting adjustment can be implemented. During the installation of the dome-shaped camera 50 after the assembly thereof, the camera body 52 is manually rotated and adjusted to a desired tilt angle and then the bolts 63 are sufficiently fastened to the nuts 53c. Thus, the tilting adjustment is completed, and the camera body 52 is maintained at the desired tilt angle.

During the assembly of the camera unit 51, under the conditions where the camera body 52 and the gimbals 54 are combined together, the gimbals base 54k is connected with the bottom portion 1b6 of the ceiling portion 1b of the casing 1.

Specifically, the gimbals base 54k is pressed into the casing 1 along a direction DR3 in FIG. 3 and is passed over the claws 1k1 on the engagement projections 1k of the bottom portion 1b6 while the engagement projections 1k are bent inward. When the gimbals base 54k is passed over the claws 1k1, the lower surface 54kb (see FIG. 7) of the gimbals base 54k elastically meets the contact portions 1n1 of the support arms 1n on the ceiling portion 1b.

The elastic contact between the gimbals base 54k and the contact portions 1n1 of the support arms 1n limits further movement of the gimbals base 54k in the direction DR3 (the pressing direction). The outward-facing surfaces of the wall projections 1m engage the gimbals base 54, thereby centering the gimbals base 54 at the casing axis CL. The claws 1k1 on the engagement projections 1k are in engagement with the gimbals base 54k, and limit movement of the gimbals base 54k in a falling-off direction (a direction opposite to the direction DR3). Accordingly, the gimbals base 54k is held with respect to the bottom portion 1b6.

The gimbals base 54k can rotate about the casing axis CL while being held with respect to the bottom portion 1b6. The gimbals base 54k is elastically urged by the support arms 1n while being in engagement with the claws 1k1 on the engagement projections 1k. Thus, the gimbals base 54k slips on the contact portions 1n1 of the support arms 1n and the claws 1k1 of the engagement projections 1k and hence receives frictional forces therefrom when rotating about the casing axis CL. The frictional forces give a good feel concerning an adjustment of camera's panning position.

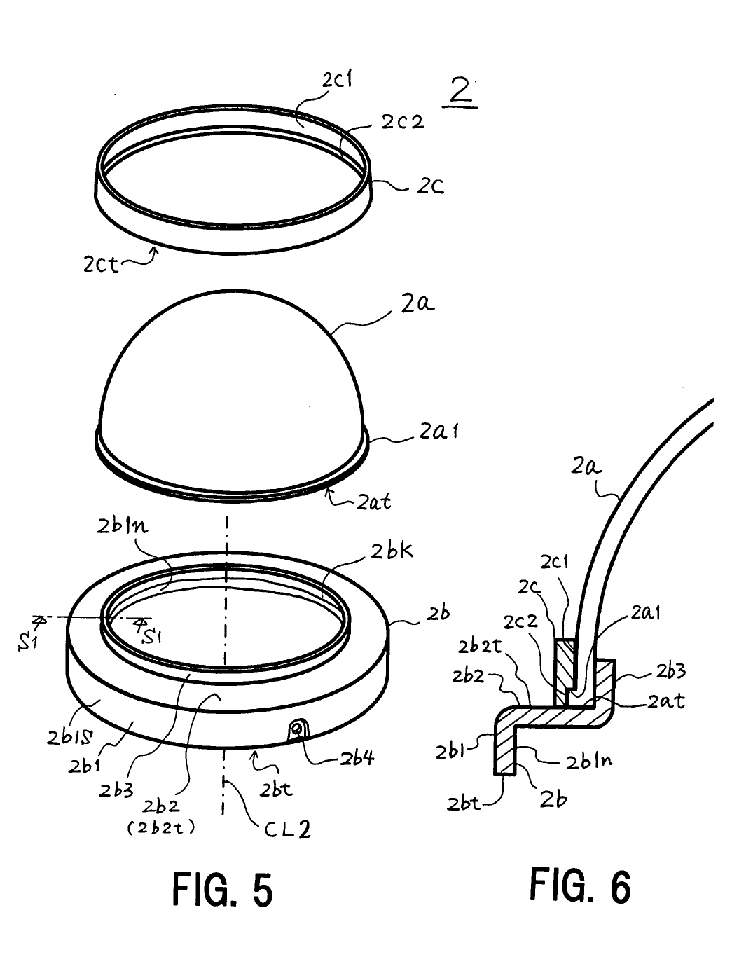

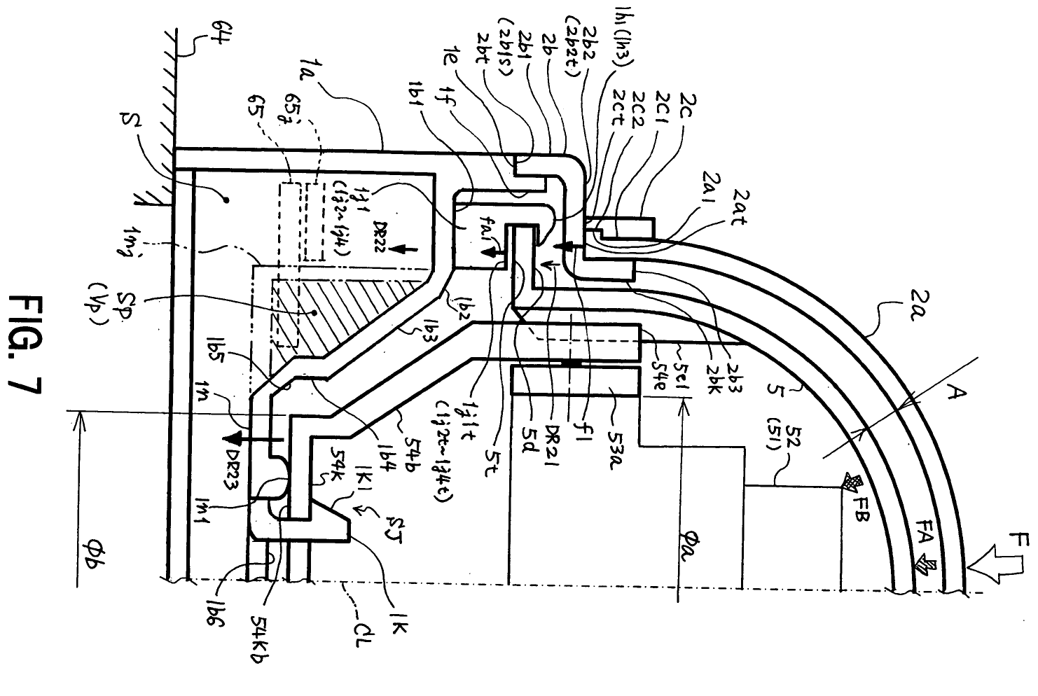

With reference to FIGS. 5 and 6, the cover 2 includes the dome-shaped member 2a, an annular flange 2b, and a fixing ring 2c coaxial with each other. The cover member 2a has an end surface 2at abutting against the flange 2b. The cover member 2a is secured to the flange 2b by the fixing ring 2c.

The cover member 2a takes an approximately hemispherical shape. A radially-outward projection forming a flange 2a1 is provided on an annular end of the cover member 2a. The flange 2a1 extends throughout the circumference defined by the annular end of the cover member 2a.

Preferably, the cover member 2a is made of at least partly transparent resin such as PC resin. Generally, PC resin is excellent in impact resistance. Thus, in the case where PC resin is used for the cover member 2a, the resultant dome-shaped camera 50 is rugged.

The resin for the cover member 2a is colored or colorless. In the case where the camera body 52 within the cover member 2a is required to be inconspicuous when seen from the exterior, it is preferable that the resin for the cover member 2a has a gray-based color.

The flange 2b takes a ring shape having a central opening 2bk and an axis (a center line) CL2. Preferably, the flange 2b is made of resin in terms of cost performance. Alternatively, the flange 2b may be made of metal such as aluminum.

The flange 2b has a circumferential wall portion 2b1, a ceiling portion 2b2, and a circumferential rib 2b3. The circumferential wall portion 2b1 has an outer circumferential surface 2b1s. The ceiling portion 2b2 connects with the circumferential wall portion 2b1. The ceiling portion 2b2 has a ceiling surface 2b2t which extends from the circumferential wall portion 2b1 toward the flange axis CL2. The circumferential rib 2b3 is provided on the inner edge of the ceiling portion 2b2 which surrounds and defines the central opening 2bk. The circumferential rib 2b3 extends throughout the circumference of the central opening 2bk. The circumferential rib 2b3 projects from the ceiling portion 2b2 along a direction parallel to the flange axis CL2.

Preferably, the ceiling surface 2b2t is perpendicular to the flange axis CL2. The ceiling surface 2b2 may be slightly inclined relative to a plane perpendicular to the flange axis CL2.

The circumferential wall portion 2b1 has an inner surface 2b1n. The dimensions and shape of the inner surface 2b1n are chosen so that the inner surface 2b1 will contact or adjacently oppose a part of an outer circumferential surface of the circumferential wall portion 1f in the ceiling portion 1b of the casing 1.

The circumferential wall portion 2b1 is formed with a hole 2b4 for accommodating a screw or bolt 64 used to fix the circumferential wall portion 2b1 to the casing 1. There may be two diametrically-opposed holes 2b4.

The circumferential rib 2b3 has an outer circumferential surface, the dimensions and shape of which are chosen so that the outer circumferential surface will contact or adjacently oppose an inner circumferential surface of the cover member 2a at or near its end.

The fixing ring 2c has an inner circumferential surface 2c1 and a recess 2c2 for accommodating the flange 2a1 of the cover member 2a. The dimensions and shape of the inner circumferential surface 2c1 of the fixing ring 2c are chosen so that the inner circumferential surface 2c1 will contact or adjacently oppose an outer circumferential surface of the end of the cover member 2a. Preferably, the fixing ring 2c is made of resin such as PC resin or HIPS (high impact polystyrene) resin. Alternatively, the fixing ring 2c may be made of metal such as aluminum.

During the assembly of the cover 2, the cover member 2a is fitted to the flange 2b while the circumferential rib 2b3 on the flange 2b is moved into the cover member 2a and the end surface 2at of the cover member 2a contacts the ceiling surface 2b2t of the ceiling portion 2b2 in the flange 2b. Thus, the ceiling surface 2b2t of the flange 2b provides a contact portion in touch with the end of the cover member 2a.

Thereafter, the fixing ring 2c is fitted to the cover member 2a and the flange 2b from above as viewed in FIG. 5 in a manner such that an end surface 2ct of the fixing ring 2c contacts the ceiling surface 2b2t of the ceiling portion 2b2 in the flange 2b and the flange 2a1 of the cover member 2a is accommodated in the recess 2c2 in the fixing ring 2c. In this way, the cover member 2a, the flange 2b, and the fixing ring 2c are fitted to each other as shown in FIG. 6. Under the conditions where the cover member 2a, the flange 2b, and the fixing ring 2c are fitted to each other, they are bonded together to form a single body in one of ways indicated below.

The first way uses adhesive for bonding the cover member 2a, the flange 2b, and the fixing ring 2c together. The second way uses snap fits for firmly connecting the cover member 2a, the flange 2b, and the fixing ring 2c together. In this case, the cover member 2a, the flange 2b, and the fixing ring 2c are formed with engagement claws for implementing the snap fits. The third way uses threads of screws provided on opposing surfaces of the cover member 2a, the flange 2b, and the fixing ring 2c. In this case, the cover member 2a, the flange 2b, and the fixing ring 2c are firmly connected together by the screws. The fourth way uses ultrasonic welding for bonding the cover member 2a, the flange 2b, and the fixing ring 2c together. The fourth way premises that the cover member 2a, the flange 2b, and the fixing ring 2c are made of resin.

With reference back to FIG. 2, the inner cover 5 has a crown portion 5b, a cylindrical barrel portion 5c, and a flange 5d arranged in that order. The crown portion 5b takes an approximately hemispherical shape. The barrel portion 5c coaxially connects with the crown portion 5b. The crown portion 5b and the barrel portion 5c have a common axis (center line) CL5. The flange 5d projects radially outward from an end of the barrel portion 5c. The flange 5d extends substantially throughout the circumference of the end of the barrel portion 5c.

The inner cover 5 has a slit-like opening 5a extending in an area containing a zone at and near the top end (apex) of the crown portion 5b. The opening 5a further extends into the barrel portion 5c. The opening 5a is designed to allow the camera unit 51 to continuously take images of an external scene while the lens section 3 is tilted between a minimum degree and a maximum degree. Thus, the opening 5a corresponds to the image taking range of the camera unit 51.

An inner surface of the barrel portion 5c is formed with two pairs of ribs 5e1 and 5e2 extending in parallel to the axis CL5 of the barrel portion 5c. The rib pairs are circumferentially spaced from the opening 5a at an angular interval of about 90°. There is a prescribed interval between the rib pairs.

The rib pairs correspond to the ribs 54e on the opposite sides of one engagement portion 54c in the gimbals 54, respectively. In each of the rib pairs, the interval between the ribs 5e1 and 5e2 and the dimensions and shape of the ribs 5e1 and 5e2 are chosen so that the rib 54e on the engagement portion 54c can fit into a region between the ribs 5e1 and 5e2 in the corresponding rib pair.

Preferably, the inner cover 5 is made of light-shading or light-shielding resin such as PC resin.

During the assembly of the dome-shaped camera 50, the cover 2 and the inner cover 5 are attached to the casing 1 as follows.

First, the inner cover 5 is moved toward the casing 1 along a direction DR5 in FIG. 2 before being attached to the casing 1. The flange 5d of the inner cover 5 is brought into contact with the claw-added projections 1h1 and 1h3 on the casing 1 and is passed over the claws of the projections 1h1 and 1h3. Then, the flange 5d meets the contact ribs 1j1-1j4 on the casing 1, and the flange 5d is held between the claws of the projections 1h1 and 1h3 and the contact ribs 1j1-1j4 on the casing 1. In this way, the inner cover 5 is attached to the casing 1.

At this time, the end surface 5t of the inner cover 5 (that is, the lower surface of the flange 5d as viewed in FIG. 2) abuts against the top surfaces 1j1t-1j4t of the contact ribs 1j1-1j4.

During the movement of the inner cover 5 relative to the casing 1, the outer circumferential surface of the flange 5d on the inner cover 5 is guided by the inwardly-facing surfaces of the claw-added projections 1h1 and 1h3 and the claw-less projections 1h2 and 1h4 on the casing 1 so that the inner cover 5 is reliably centered at the casing axis CL. When the inner cover 5 is normally attached to the casing 1, each rib 54e on the gimbals 54 fits in the region between the ribs 5e1 and 5e2 in the corresponding rib pair on the inner cover 5.

Thereby, the inner cover 5 is held on the casing 1 while the rotation of the inner cover 5 about the casing axis CL is limited.

Thereafter, the cover 2 is moved toward the casing 1, to which the inner cover 5 has been attached, in the direction D1 before being attached to the casing 1. Specifically, the circumferential wall portion 2b1 of the flange 2b on the cover 2 is fitted around the circumferential wall portion if in the casing 1. At this time, the end surface 2bt of the circumferential wall portion 2b1 of the flange 2b abuts against the step 1e on the casing 1 (see FIG. 7). Thus, the end surface 2bt of the flange 2b provides a contact portion in touch with the casing 1. In the flange 2b, the contact portion in touch with the casing 1 is located radially outward of the contact portion in touch with the casing member 2a.

Subsequently, the bolt 64 is passed through the hole 2b4 in the flange 2b on the cover 2, and is then driven into mesh with the nut 62 on the circumferential wall portion 1f in the casing 1 so that the cover 2 and the casing 1 are firmly connected together. Two bolts 64 may be used to connect the cover 2 and the casing 1.

In the dome-shaped camera 50, the support arms 1n on the casing 1 serve as means for urging the gimbals base 54k in a direction away from the casing 1 and parallel to the casing axis CL. The claws 1k1 of the engagement projections 1k on the casing 1 serve as means for limiting movement of the gimbals base 54k in the direction away from the casing 1 and parallel to the casing axis CL.

With reference to FIG. 7, a top of the cover member 2a in the dome-shaped camera 50 is struck with a hammer or a bat, and hence receives an impact. Accordingly, an impact force F is applied to the top of the cover member 2a. The impact force F travels to the ceiling surface 2b2t of the ceiling portion 2b2 in the flange 2b via the end surface 2at of the cover member 2a which abuts against the ceiling surface 2b2t. The impact force F becomes a force f1 applied from the end surface 2at to the ceiling surface 2b2t.

Since the end surface 2at of the cover member 2a contacts the ceiling surface 2b2t of the ceiling portion 2b2 in the flange 2b throughout the circumference thereof, the force f1 is scattered so that a concentrated stress is absent from the cover member 2a. Therefore, impact-responsive deformations of the end of the cover member 2a and a portion of the cover member 2a near the end are suppressed or prevented.

Similarly, a concentrated stress is absent from the ceiling surface 2b2t of the ceiling portion 2b2 in the flange 2b. As previously mentioned, the force f1 is scattered. Therefore, the flange 2b hardly deforms in response to the impact on the cover member 2a.

The radial position of the contact between the cover member 2a and the flange 2b differs from that of the contact between the flange 2b and the casing 1. Thus, the flange 2b can elastically bend in a direction DR21 in response to the force f1 so that a portion of the force f1 can be absorbed.

Therefore, a weaker force caused by the impact force F is transmitted from the flange 2b to the step 1e on the casing 1. Consequently, the cover member 2a, the flange 2b, and the casing 1 are hardly deformed and damaged by the impact on the cover member 2a.

The step 1e is located at a position corresponding to the outer cylindrical portion 1a of the casing 1 so that the casing 1 is hardly deformed by a force applied to the step 1e which originates from the impact force F. The force applied to the step 1e travels and escapes to the ceiling board 61 through the outer cylindrical portion 1a substantially without damping.

In the case where the impact force F is so strong that the cover member 2a is deformed and brought into contact with the inner cover 5, the impact force F travels from the cover member 2a to the inner cover 5 as an impact force FA.

The impact force FA travels to the top surfaces 1j1t-1j4t of the contact ribs 1j1-1j4 on the casing 1 via the end surface 5t of the inner cover 5 which abuts against the top surfaces 1j1t-1j4t. The impact force FA becomes a force fa1 applied from the end surface 5t to the top surfaces 1j1t-1j4t. Since there are four pairs of the contact ribs 1j1-1j4, each of the contact ribs 1j1-1j4 receives one eighth of the force fa1.

In the casing 1, the contact ribs 1j1-1j4 are provided on the reference plane portion 1b1 which extends radially inward of the outer cylindrical portion 1a. Thus, the contact ribs 1j1-1j4 can be deformed downward along a direction DR22 to a certain degree as viewed in FIG. 7 when receiving a strong force. The force fa1 coming from the inner cover 5 is distributed to the contact ribs 1j1-1j4 so that each of the contact ribs 1j1-1j4 is subjected to a weaker stress and deforms only slightly.

The reference plane portion 1b1 of the casing 1 can elastically deform to a certain degree. A portion of the impact force FA which travels to the reference plane portion 1b1 via the contact ribs 1j1-1j4 can be at least partially absorbed by the deformation of the reference plane portion 1b1.

In the case where the impact force FA applied to the inner cover 5 is so strong that the inner cover 5 is deformed and brought into contact with the camera body 52, the impact force FA travels from the inner cover 5 to the camera body 52 as an impact force FB.

The impact force FB is caused by a portion of the impact force FA applied to the inner cover FA. The impact force FB is applied to the camera body 52.

The impact force FB travels from the camera body 52 to the gimbals 54 via the support tabs 53a on the ring bracket 53.

The gimbals 54 supports the camera body 52 through the ring bracket 53. The ribs 54e of the engagement portions 54c in the gimbals 54 are connected with and guided by the ribs 5e1 and 5e2 on the inner cover 5. Thus, the gimbals 54 may be moved downward along a direction DR23 as viewed in FIG. 7 when receiving the impact force FB.

The lower surface 54kb of the gimbals base 54k touches the contact portions 1n1 of the support arms 1n on the casing 1. Thus, as the gimbals 54 is moved along a direction D23, the support arms 1n are elastically deformed along the direction D23 also. Accordingly, the support arms 1n softly support the gimbals 54. The support arms 1n absorb kinetic energy given to the camera body 52 in accordance with the impact force FB. Therefore, damage to the camera body 52 due to the impact force FB is effectively suppressed.

In the dome-shaped camera 50, an impact force applied to the cover member 2a can propagate therefrom to the casing 1 via three paths (first, second, and third paths). The first path has a sequence of the cover member 2a, the flange 2b, and the casing 1. The second path has a sequence of the cover member 2a, the inner cover 5, and the casing 1. The third path has a sequence of the cover member 2a, the inner cover 5, the camera body 52, the gimbals 54, and the casing 1.

An impact force propagating along the first path is damped especially by a deformation of the flange 2b. An impact force propagating along the second path is damped especially by a deformation of the reference plane portion 1b1 in the casing 1. Regarding an impact force propagating along the third path, kinetic energy of the camera body 52 is absorbed especially by deformations of the gimbals 54 and the support arms 1n on the casing 1.

In the dome-shaped camera 50, an impact force applied to the cover member 2a is prevented from directly traveling to the camera body 52. Generally, only a sufficiently-damped impact force reaches the camera body 52. In the event that the camera body 52 is moved by a transmitted impact force, kinetic energy of the camera body 52 is effectively absorbed so that damage to the camera body 52 is suppressed or prevented.

In the dome-shaped camera 50, the outside diameter φb of the base 54k of the gimbals 54 is smaller than the outside diameter φa of the camera base 52a. Accordingly, the volume of the interior space S of the casing 1 is increased as compared with an assumed case where the outside diameter φb is equal to the outside diameter φa.

With reference to FIG. 7, the two-dot dash lines denote the outlines of the support arms 1n in the assumed case where the outside diameter φb is equal to the outside diameter φa. The above-mentioned increase in the volume of the interior space S of the casing 1 corresponds to the sectional zone SP surrounded by the two-dot dash lines and the solid lines. The volume increase is equal to an annular space Vp formed by one revolution of the zone SP about the casing center CL.

The ribs 5e1 and 5e2 on the inner cover 5 are in engagement with the ribs 54e on the gimbals 54. This engagement is designed to provide a guide structure by which the camera body 52 can move only in directions parallel to the casing axis CL. Therefore, even when the outside diameter φb of the gimbals base 54k is relatively small, the camera body 52 supported on the gimbals base 54k is prevented from swinging about of fulcrums formed by support portions SJ on the casing 1.

The increased interior space S of the casing 1 can accommodate more parts (electronic parts) and larger circuit boards, being advantageous in designing the dome-shaped camera 50 to have more multiple-functions.

The dome-shaped camera 50 can be more compact although the casing 1 contains parts and circuit boards similar to those in a conventional camera.

With reference to FIG. 7, in the assumed case where the outside diameter φb of the base 54k of the gimbals 54 is equal to the outside diameter φa of the camera base 52a, a widest circuit board which can be accommodated in the casing 1 is denoted by the broken lines 65j. On the other hand, in the dome-shaped camera 50, a widest circuit board which can be accommodated in the casing 1 is denoted by the broken lines 65. The circuit board 65 is larger than the circuit board 65j. Thus, the dome-shaped camera 50 is advantageous in that the casing 1 can accommodate more parts (electronic parts) and larger circuit boards.

In the event that the cover member 2a in the dome-shaped camera 50 is struck with a hammer or a bat and hence receives an impact force, the end surface 2at of the cover member 2a contacts the ceiling surface 2b2t of the ceiling portion 2b2 in the flange 2b throughout the circumference thereof and the impact force is transmitted from the cover member 2a to the flange 2b. Therefore, even in this case, a concentrated stress is absent from the cover member 2a. Thus, the cover member 2a except the point of the application of the impact force is hardly deformed or damaged.

The ceiling surface 2b2t of the ceiling portion 2b2 in the flange 2b contacts the end surface 2at of the cover member 2a. The end surface 2bt of the circumferential wall portion 2b1 of the flange 2b surface-contacts the step 1e on the casing 1 substantially throughout the circumference thereof, and the impact force is transmitted from the flange 2b to the casing 1. The step 1e is located at a position corresponding to the outer cylindrical portion 1a of the casing 1. The flange 2b can elastically deform in a manner like shearing between its inner part and its outer part. This elastic deformation of the flange 2b absorbs a portion of the impact force transmitted from the cover member 2a.

Preferably, an outer portion of the casing 1 which defines the step 1e is high in rigidity. As mentioned above, the flange 2b surface-contacts the step le on the casing 1 substantially throughout the circumference thereof. The casing 1 receives an impact force from the flange 2b, and transmits the received force to the ceiling board 61 substantially as it is. A concentrated stress hardly occurs in the flange 2b. Thus, it is possible to reliably prevent the flange 2b from being deformed or damaged by the impact force applied thereto.

In the case where the impact force is so strong that the cover member 2a is deformed and brought into contact with the inner cover 5, the impact force travels from the cover member 2a to the inner cover 5. In this case, the end surface 5t of the inner cover 5 contacts the top surfaces 1j1t-1j4t of the contact ribs 1j1-1j4 on the casing 1. Thus, the impact force applied to the inner cover 5 is prevented from directly traveling to the camera body 52. Accordingly, it is possible to prevent the camera body 52 from being damaged.

The impact force applied to the inner cover 5 travels to the casing 1 via the contact ribs 1j1-1j4. In the casing 1, the contact ribs 1j1-1j4 are provided on the reference plane portion 1b1 which extends radially inward of the outer cylindrical portion 1a. Thus, the reference plane portion 1b1 of the casing 1 can be elastically deformed relative to the outer cylindrical portion 1a in a direction along the casing axis CL. A portion of the impact force which travels to the reference plane portion 1b1 via the contact ribs 1j1-1j4 can be at least partially absorbed by the deformation of the reference plane portion 1b1.

In the case where the impact force applied to the inner cover 5 is so strong that the inner cover 5 is deformed and brought into contact with the camera body 52, the impact force travels from the inner cover 5 to the camera body 52. In the gimbals 54, the pair of the arms 54a, which support the camera body 52 and which extend axially and radially outward, are elastically deformed by the impact force exerted on the camera body 52. A portion of the impact force is absorbed by the elastic deformation of the arms 54a so that the camera body 52 is prevented from being damaged.

The gimbals 54 is supported by the support arms 1n on the casing 1 while being movable along the casing axis CL. The support arms 1n are flexible. Thus, the support arms 1n are elastically deformed by the impact force transmitted from the camera body 52 to the gimbals 54. A portion of the impact force is absorbed by the elastic deformation of the support arms 1n. Accordingly, the camera body 52 is more reliably prevented from being damaged.

The gimbals 54 has the base 54k which is held at the bottom portion 1b6 in the ceiling portion 1b of the casing 1 via the snap fit. The gimbals base 54k is smaller in external shape or outside diameter than the camera body 52 so as to provide the increased interior space S of the casing 1. Therefore, the larger circuit board 65 can be placed in the interior space S of the casing 1. Furthermore, more parts or larger parts can be placed in the interior space S of the casing 1.

In the cover 2, the end of the cover member 2a fits around the circumferential rib 2b3 of the flange 2b, and the end surface 2at of the cover member 2a abuts against the ceiling surface 2b2t of the ceiling portion 2b2 in the flange 2b. The cover member 2a is secured to the flange 2b by the fixing ring 2c which fits around the end of the cover member 2a. This structure of the cover 2 makes it possible to prevent a concentrated stress from occurring in a place of the contact between the cover member 2a and the flange 2b and a region near that place.

As previously mentioned, the fixing ring 2c secures the cover member 2a to the flange 2b. The fixing ring 2c may be detachably connected with the flange 2b via, for example, a snap fit or a screw. In this case, it is possible to replace the cover member 2a after the installation of the dome-shaped camera 50. Thus, the maintenance of the dome-shaped camera 50 can be easy.

In the dome-shaped camera 50, the cover member 2a and the inner cover 5 are hardly deformed when an impact force is applied to the cover member 2a. Accordingly, the clearance A between the cover member 2a and the inner cover 5, and the clearance between the inner cover 5 and the camera body 52 can be relatively small.

The clearance A between the cover member 2a and the inner cover 5 is set to, for example, 1.5 mm. The 1.5-mm clearance A is equal to about four fifth of that in a conventional dome-shaped camera. Accordingly, the dome-shaped camera 50 can be smaller in size than the conventional one.

The nuts 62 embedded in the circumferential wall portion 1f of the casing 1 may be omitted. In this case, the bolt or bolts 64 are replaced by a self-tapping screw or screws driven into a small through hole or holes in the wall of the casing 1.

What is claimed is:

1. A dome-shaped camera comprising:
a casing having an axis;
a camera portion supported on the casing;
a dome-shaped cover being at least partly transparent and covering the camera portion;
a flange portion having a first contact portion and a second contact portion, the first contact portion being in contact with an end of the dome-shaped cover, the second contact portion being in contact with the casing, wherein a position of the first contact portion in a radial direction with respect to the axis of the casing differs from that of the second contact portion; and
means for fixing the flange portion to the casing.

2. A dome-shaped camera as recited in claim 1, further comprising:
an inner cover placed inward of the dome-shaped cover and covering the camera portion, the inner cover having an opening corresponding to an image taking range of the camera portion; and
a third contact portion provided on the casing at a position radially inward of an outer circumference of the casing, the third contact portion being in contact with an end surface of the inner cover.

3. A dome-shaped camera as recited in claim 1, wherein the camera portion is elastically movable toward the casing in a direction along the axis of the casing.

4. A dome-shaped camera as recited in claim 2, wherein the camera portion is elastically movable toward the casing in a direction along the axis of the casing.

5. A dome-shaped camera comprising:
a camera portion;
an arm portion having one end connected with the camera portion;
a gimbals base with which an other end of the arm portion is integrally connected;
a casing having an axis and a support portion for elastically supporting the gimbals base; and
a dome-shaped cover attached to the casing and covering the camera portion, the dome-shaped cover being at least partly transparent;
wherein an image of the gimbals base projected onto a plane perpendicular to the axis of the casing is smaller in area than an image of the camera portion projected onto the plane.

6. A dome-shaped camera as recited in claim 5, wherein the support portion comprises means for urging the gimbals base in a direction away from the casing and parallel to the axis of the casing, and means for limiting movement of the gimbals base in the direction away from the casing and parallel to the axis of the casing.

7. A dome-shaped camera as recited in claim 5, further comprising:
an inner cover placed inward of the dome-shaped cover and covering the camera portion, the inner cover having an opening corresponding to an image taking range of the camera portion, the inner cover further having a guide portion in engagement with the arm portion for guiding the arm portion along the axis of the casing.

8. A dome-shaped camera as recited in claim 5, further comprising at least one of a circuit board and electronic parts placed in the casing at a position radially outward of the support portion.

9. A dome-shaped camera as recited in claim 6, further comprising:
an inner cover placed inward of the dome-shaped cover and covering the camera portion, the inner cover having an opening corresponding to an image taking range of the camera portion, the inner cover further having a guide portion in engagement with the arm portion for guiding the arm portion along the axis of the casing.

10. A dome-shaped camera as recited in claim 6, further comprising at least one of a circuit board and electronic parts placed in the casing at a position radially outward of the support portion.

11. A dome-shaped camera as recited in claim 7, further comprising at least one of a circuit board and electronic parts placed in the casing at a position radially outward of the support portion.
